(19) United States
(12) Patent Application Publication
(10) Pub. No.: US 2022/0286025 A1
(43) Pub. Date: Sep. 8, 2022

(54) ROTARY ELECTRIC MACHINE AND DRIVE DEVICE

(71) Applicant: NIDEC CORPORATION, Kyoto (JP)

(72) Inventors: Hitoshi KUROYANAGI, Kyoto (JP); Yuki ISHIKAWA, Kyoto (JP); Keisuke NAKATA, Kyoto (JP)

(21) Appl. No.: 17/684,340

(22) Filed: Mar. 1, 2022

(30) Foreign Application Priority Data
Mar. 8, 2021 (JP) 2021-036633

(51) Int. Cl. H02K 11/33; H02K 5/22; H02K 9/19; B60L 50/51

(52) U.S. Cl. CPC H02K 11/33; H02K 5/225; H02K 9/19; B60L 50/51; H02K 2203/09

(57) ABSTRACT

Provided is a rotary electric machine including a rotor, a stator, a housing, an inverter device, a bus bar, and a pipe member in a hollow shape accommodated inside the housing. The housing is provided inside with a first region located between an outer surface of a stator core and an inner surface of the housing as viewed in an axial direction, and a second region located between the outer surface of the stator core and the inner surface of the housing as viewed in the axial direction while being disposed apart from the first region in a circumferential direction. The second region is wider than the first region. The pipe member overlaps the first region as viewed in the axial direction. The bus bar overlaps the second region as viewed in the axial direction.

### CROSS-REFERENCE TO RELATED APPLICATIONS

The present invention claims priority under 35 U.S.C. § 119 to Japanese Patent Application No. 2021-036633 filed on Mar. 8, 2021, the entire content of which is incorporated herein by reference.

### FIELD OF THE INVENTION

The present invention relates to a rotary electric machine and a drive device.

### BACKGROUND

There is known a rotary electric machine including a cooling pipe. For example, conventionally a rotary electric machine including a cooling pipe disposed vertically above the most vertically upward position on an outer peripheral surface of a stator yoke is known.

The rotary electrical machine as described above increases in size by size of the cooling pipe provided. The rotary electric machine as described above may be provided with an inverter device. In this case, the rotary electric machine further increases in size by size of the inverter device. As described above, there is a problem that the rotary electric machine provided with the cooling pipe and the inverter device are likely to increase in size.

### SUMMARY

A rotary electric machine according to an aspect of the present invention includes a rotor rotatable about a central axis, a stator having a stator core facing the rotor across a gap, a housing for accommodating the rotor and the stator inside, an inverter device electrically connected to the stator, a bus bar electrically connecting the stator and the inverter device, and a pipe member in a hollow shape accommodated inside the housing. The housing is provided inside with a first region located between an outer surface of the stator core and an inner surface of the housing as viewed in an axial direction, and a second region located between the outer surface of the stator core and the inner surface of the housing as viewed in the axial direction while being disposed apart from the first region in a circumferential direction. The second region is wider than the first region. The pipe member overlaps the first region as viewed in the axial direction. The bus bar overlaps the second region as viewed in the axial direction.

A drive device according to an aspect of the present invention is mounted on a vehicle, and includes the rotary electric machine described above, and a transmission device that is connected to the rotary electric machine and transmits rotation of the rotary electric machine to an axle of the vehicle.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a schematic structural view schematically showing a drive device according to a first preferred embodiment;

FIG. 2 is a sectional view showing the drive device according to the first preferred embodiment, and is a sectional view taken along line II-II in FIG. 1;

FIG. 3 is a perspective view showing a stator core and a pipe member according to the first preferred embodiment;

FIG. 4 is a sectional view schematically showing a rotary electric machine according to a second preferred embodiment; and

FIG. 5 is a sectional view schematically showing a rotary electric machine according to a third preferred embodiment.

### DETAILED DESCRIPTION

In the following description, a vertical direction is defined and described based on a positional relationship when a drive device according to an preferred embodiment is mounted on a vehicle positioned on a horizontal road surface. That is, a relative positional relationship with respect to the vertical direction described in the following preferred embodiments needs to be satisfied at least when the drive device is mounted on a vehicle positioned on a horizontal road surface.

In the drawings, an xyz coordinate system is shown appropriately as a three-dimensional orthogonal coordinate system. In the XYZ coordinate system, a Z-axis direction corresponds to the vertical direction. An arrow in the Z-axis is directed toward a side (+Z side) that is an upper side in the vertical direction, and a side (−Z side) opposite to the side toward which the arrow in the Z-axis is directed is a lower side in the vertical direction. In the following description, the upper side and the lower side in the vertical direction will be referred to simply as the “upper side” and the “lower side”, respectively. An X-axis direction is orthogonal to the Z-axis direction and corresponds to a front-rear direction of the vehicle on which the drive device is mounted. In the following preferred embodiments, a side (+X side) toward which an arrow in the X-axis is directed is a front side in the vehicle, and a side (−X side) opposite to the side toward which the arrow in the X-axis is directed is a rear side in the vehicle. A Y-axis direction is orthogonal to both the X-axis direction and the Z-axis direction and corresponds to a left-right direction of the vehicle, i.e., a vehicle lateral direction. In the following preferred embodiments, a side (+Y side) toward which an arrow in the Y-axis is directed is a left side in the vehicle, and a side (−Y side) opposite to the side toward which the arrow in the Y-axis is directed is a right side in the vehicle. The front-rear direction and the left-right direction are each a horizontal direction orthogonal to the vertical direction.

A positional relationship in the front-rear direction is not limited to the positional relationship of the following preferred embodiments. The side (+X side) toward which the arrow in the X-axis is directed may be the rear side in the vehicle, and the side (−X side) opposite to the side toward which the arrow in the X-axis is directed may be the front side in the vehicle. In this case, the side (+Y side) toward which the arrow in the Y-axis is directed is the right side in the vehicle, and the side (−Y side) opposite to the side toward which the arrow in the Y-axis is directed is the left side in the vehicle. In the present specification, a “parallel direction” includes a substantially parallel direction, and an “orthogonal direction” includes a substantially orthogonal direction.

A central axis J showed in the drawings as appropriate is a virtual axis extending in a direction intersecting the vertical direction. More specifically, the central axis J extends in the Y-axis direction orthogonal to the vertical direction, i.e., in the left-right direction of the vehicle. In description below, unless otherwise particularly stated, a direction parallel to the central axis J is simply referred to as the “axial direction”, a radial direction about the central axis J is simply referred to as the “radial direction”, and a circumferential direction about the central axis J, i.e., a direction around the central axis J is simply referred to as the “circumferential direction”. In the following preferred embodiments, the right side (−Y side) is referred to as a “first axial side”, and the left side (+Y side) is referred to as a “second axial side”.

An arrow θ appropriately showed in the drawing indicates the circumferential direction. In the following description, a side advancing clockwise about the central axis J as viewed from the right side in the circumferential direction, i.e., a side (+θ side) toward which the arrow θ faces is referred to as a “first circumferential side”, and a side advancing counterclockwise about the central axis J as viewed from the right side in the circumferential direction, i.e., a side (−θ side) opposite to the side toward which the arrow θ faces is referred to as a “second circumferential side”.

In the following preferred embodiments, a direction in which the Z-axis extends, i.e., the vertical direction, corresponds to a “first direction”, and a direction in which the X-axis extends, i.e., the front-back direction, corresponds to a “second direction”. The upper side corresponds to a “first side in the first direction”, and the lower side corresponds to a “second side in the first direction”.

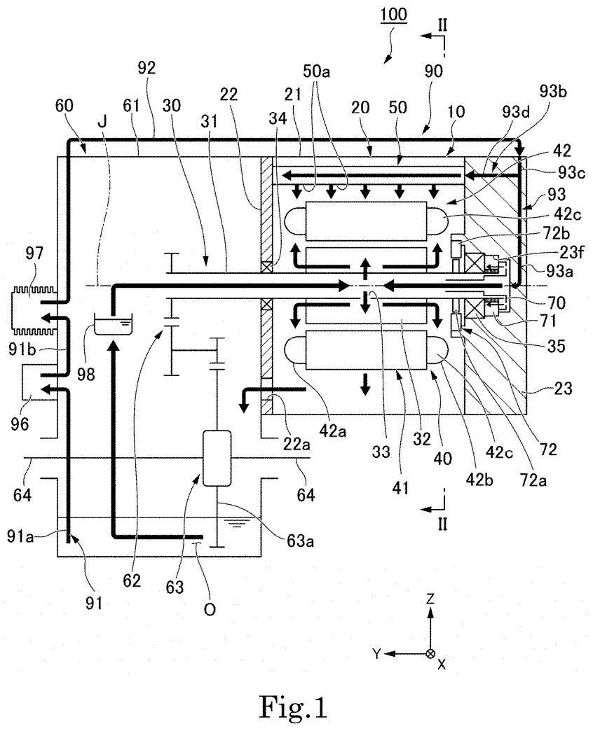

FIG. 1 illustrates a drive device 100 of the present preferred embodiment that is mounted on a vehicle and rotates an axle 64. The vehicle on which the drive device 100 is mounted is a vehicle including a motor as a power source, such as a hybrid vehicle (HEV), a plug-in hybrid vehicle (PHV), or an electric vehicle (EV). As showed in FIG. 1, the drive device 100 includes a rotary electric machine 10 and a transmission device 60. The transmission device 60 is connected to the rotary electric machine 10, and transmits rotation of the rotary electric machine 10, i.e., rotation of a rotor 30 described later, to the axle 64 of the vehicle. The transmission device 60 of the present preferred embodiment includes a gear housing 61, a speed reducer 62 connected to the rotary electric machine 10, and a differential gear 63 connected to the speed reducer 62.

The gear housing 61 internally accommodates the speed reducer 62, the differential gear 63, and oil O. The oil O is stored in a lower region in the gear housing 61. The oil O circulates in a refrigerant flow path 90 described later. The oil O is used as a refrigerant for cooling the rotary electric machine 10. The oil O is also used as lubricating oil for the speed reducer 62 and the differential gear 63. As the oil O, for example, an oil equivalent to an automatic transmission fluid (ATF) having a relatively low viscosity is preferably used to function as a refrigerant and a lubricating oil.

The differential gear 63 includes a ring gear 63a. The ring gear 63a receives torque output from the rotary electric machine 10 and transmitted through the speed reducer 62. The ring gear 63a has a lower end portion immersed in the oil O stored in the gear housing 61. When the ring gear 63a rotates, the oil O is scraped up. The oil O scraped up is supplied to, for example, the speed reducer 62 and the differential gear 63 as a lubricating oil.

The rotary electric machine 10 drives the drive device 100. The rotary electric machine 10 is located, for example, on the first axial side (−Y side) from the transmission device 60. In the present preferred embodiment, the rotary electric machine 10 is a motor. The rotary electric machine 10 includes a motor housing 20, a rotor 30 having a shaft 31, bearings 34 and 35 that rotatably support the rotor 30, a stator 40, a resolver 72, a nozzle member 70, and a static eliminator 71. The bearings 34 and 35 are each a ball bearing, for example.

The motor housing 20 internally accommodates the rotor 30 and the stator 40. The motor housing 20 is connected to the gear housing 61 on the first axial side (−Y side). The motor housing 20 has a body 21, a partition wall 22, and a lid 23. The body 21 and the partition wall 22 are each, for example, a part of a single member. The lid 23 is separate from, for example, the body 21 and the partition wall 22.

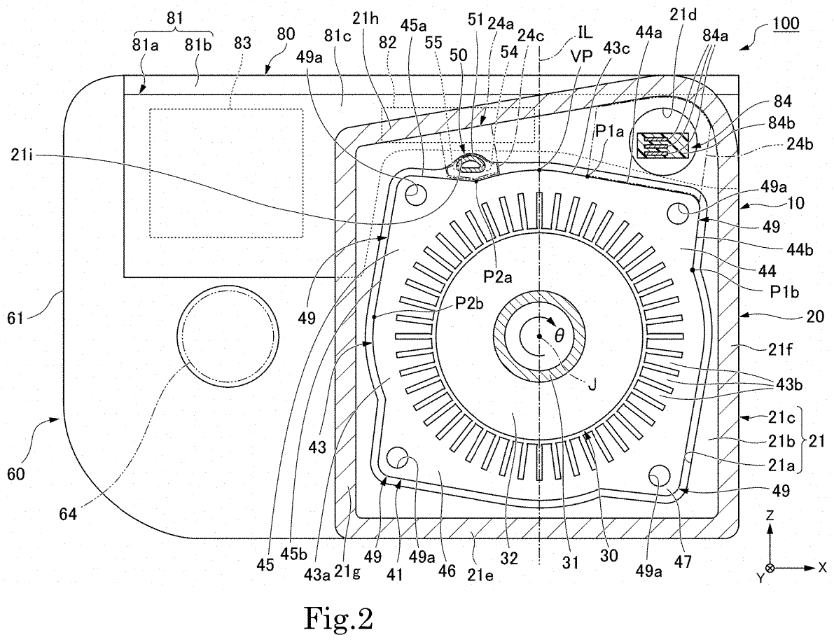

The body 21 is in a cylindrical or substantially cylindrical shape that surrounds the central axis J and opens toward the first axial side (−Y side). As showed in FIG. 2, the body 21 has a first tubular portion 21a, a flange portion 21b, and a second tubular portion 21c. The first tubular portion 21a is a tubular portion that accommodates the stator 40 inside. The first tubular portion 21a has an inner peripheral surface in a shape along an outer peripheral surface of a stator core 41 described later. In FIG. 2, the inner peripheral surface of the first tubular portion 21a faces the outer peripheral surface of the stator core 41 across a gap. Although not showed, the inner peripheral surface of the first tubular portion 21a is provided with a support portion that is in contact with the outer peripheral surface of the stator core 41.

The inner peripheral surface of the first tubular portion 21a is provided with a first recess 21i that is recessed toward an outer peripheral surface of the first tubular portion 21a. That is, the motor housing 20 has an inner surface provided with the first recess 21i that is recessed toward an outer surface of the motor housing 20. In the present preferred embodiment, the first recess 21i is provided in a portion located on the upper side and the rear side (−X side) of the inner peripheral surface of the first tubular portion 21a. In the present preferred embodiment, the first recess 21i is recessed upward. The first recess 21i has an inner surface that is, for example, in an arc or substantially arc shape concave upward as viewed in the axial direction. The first recess 21i extends in the axial direction. The first recess 21i is located above a boundary portion P2a described later.

The flange portion 21b extends radially outward from an end portion of the first tubular portion 21a on the first axial side (−Y side). The flange portion 21b is in an annular or substantially annular shape surrounding the central axis J. As viewed in the axial direction, the flange portion 21b has an outer shape that is a square or substantially square shape with rounded corners. The flange portion 21b has an upper edge that is inclined vertically from the front-rear direction. The upper edge of the flange portion 21b extends linearly upward toward the front side (+X side). The flange portion 21b is provided with a through-hole 21d that passes through the flange portion 21b in the axial direction. The through-hole 21d is provided in an upper end portion of the flange portion 21b on the front side (+X side). In the present preferred embodiment, the through-hole 21d is a circular hole. The through-hole 21d allows the inside of the motor housing 20 to communicate with the inside of an inverter case 81 described later.

The second tubular portion 21c is connected to the first tubular portion 21a on the first axial side (−Y side) with the flange portion 21b. The second tubular portion 21c protrudes from a radially outer edge portion of the flange portion 21b toward the first axial side. The second tubular portion 21c has an inner diameter that is larger than an inner diameter of the first tubular portion 21a. In the present preferred embodiment, the second tubular portion 21c is in a square tubular or substantially square tubular shape with rounded corners. The second tubular portion 21c has four sidewalls 21e, 21f, 21g, and 21h. The sidewall 21e constitutes a wall of the second tubular portion 21c on the lower side. The sidewall 21f constitutes a wall of the second tubular portion 21c on the front side (+X side). The sidewall 21g constitutes a wall of the second tubular portion 21c on the rear side (−X side). The sidewall 21h constitutes a wall of the second tubular portion 21c on the upper side. The sidewall 21e is disposed along the front-rear direction. The sidewalls 21f and 21g are disposed along the vertical direction. The sidewall 21h is disposed at an angle from the front-rear direction. The sidewall 21h is located more upward toward the front side.

As showed in FIG. 1, the partition wall 22 is connected to an end portion of the body 21 on the second axial side (+Y side). The partition wall 22 axially partitions the inside of the motor housing 20 and the inside of the gear housing 61. The partition wall 22 has a partition wall opening 22a that allows the inside of the motor housing 20 to communicate with the inside of the gear housing 61. The partition wall 22 holds a bearing 34.

The lid 23 is fixed to an end portion of the body 21 on the first axial side (−Y side). The lid 23 closes an opening of the body 21 on the first axial side. The lid 23 has a hole 23f recessed from its surface on the second axial side (+Y side) toward the first axial side. The hole 23f has a bottom on the first axial side and opens toward the second axial side. In the present preferred embodiment, the hole 23f is a circular hole about the central axis J. In the hole 23f, the bearing 35, the static eliminator 71, and the nozzle member 70 are held.

The static eliminator 71 is in electrical contact with the shaft 31 and the motor housing 20. This enables a current generated in the shaft 31 to flow to the motor housing 20. As a result, the current can be prevented from flowing from the shaft 31 to the bearings 34 and 35 that rotatably support the shaft 31. Thus, electrolytic corrosion can be prevented from occurring in the bearings 34 and 35. The nozzle member 70 is used for feeding the oil O as a fluid into the inside of the shaft 31. The nozzle member 70 is partially inserted inside the shaft 31 from the first axial side (−Y side). The lid 23 has a surface on the second axial side (+Y side) that holds the resolver 72. The resolver 72 can detect rotation of the rotor 30. The resolver 72 includes a resolver rotor 72a fixed to the shaft 31 and a resolver stator 72b that surrounds the resolver rotor 72a.

The rotor 30 is rotatable about the central axis J. The rotor 30 includes a shaft 31 and a rotor body 32. Although not showed, the rotor body 32 includes a rotor core, and a rotor magnet fixed to the rotor core. Torque of the rotor 30 is transmitted to the transmission device 60.

The shaft 31 is rotatable about the central axis J. The shaft 31 is rotatably supported by the bearings 34 and 35. The shaft 31 is a hollow shaft. The shaft 31 has a cylindrical or substantially cylindrical shape about the central axis J and extends axially. The shaft 31 is provided with a hole 33 that allows the inside of the shaft 31 to communicate with the outside of the shaft 31. The shaft 31 extends across the inside of the motor housing 20 and the inside of the gear housing 61. The shaft 31 has an end portion on the second axial side (+Y side) that protrudes into the inside of the gear housing 61. The shaft 31 is connected at the end portion on the second axial side to the speed reducer 62. The shaft 31 is open on both sides in the axial direction.

The stator 40 radially faces the rotor 30 across a gap. More specifically, the stator 40 is located radially outward of the rotor 30. The stator 40 is fixed inside the motor housing 20. The stator 40 includes the stator core 41 and a coil assembly 42.

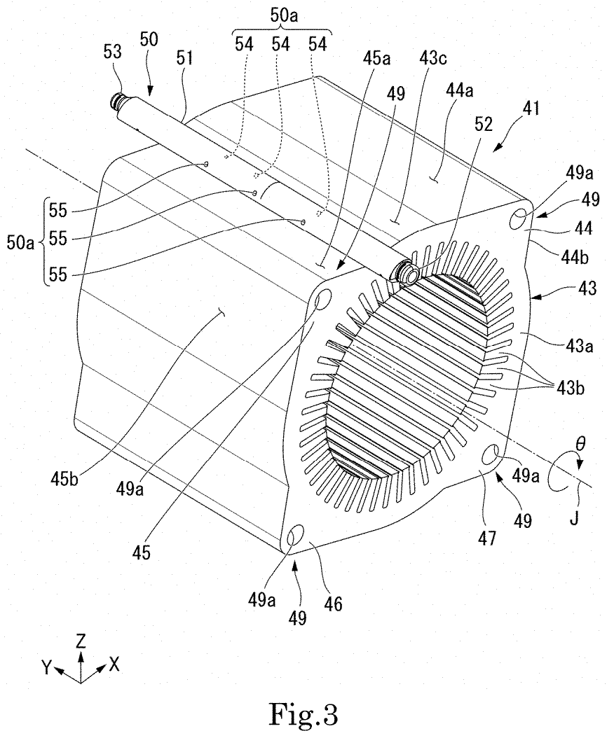

The stator core 41 is in an annular or substantially annular shape surrounding the central axis J of the rotary electric machine 10. The stator core 41 is located radially outside the rotor 30. The stator core 41 surrounds the rotor 30. The stator core 41 is composed of, for example, plate members such as electromagnetic steel plates stacked in the axial direction. As showed in FIGS. 2 and 3, the stator core 41 in the present preferred embodiment has a shape with four-fold symmetry around the central axis J.

The stator core 41 includes a stator core body 43 and a protruding portion 49. The stator core body 43 is in an annular or substantially annular shape surrounding the rotor 30. More specifically, the stator core body 43 is in a cylindrical or substantially cylindrical shape about the central axis J, and opens on both sides in the axial direction. The stator core body 43 has the outer peripheral surface 43c in a cylindrical or substantially cylindrical shape surrounding the rotor 30. In the present preferred embodiment, the outer peripheral surface 43c has a cylindrical or substantially cylindrical shape about the central axis J. The outer peripheral surface 43c constitutes a part of an outer peripheral surface of the stator core 41. In the present preferred embodiment, the outer peripheral surface of the stator core 41 is composed of the outer peripheral surface 43c and a radially outer surface of the protruding portion 49. Although not showed, the outer peripheral surface 43c is supported from radially outside by a support portion provided on the inner peripheral surface of the motor housing 20. The outer peripheral surface 43c is disposed radially facing a portion, which is provided with no support portion, of the inner peripheral surface of the motor housing 20 across a gap.

The stator core body 43 is in a cylindrical core back 43a extending in the axial direction and a plurality of teeth 43b extending radially inward from the core back 43a. The core back 43a has an outer peripheral surface that is the outer peripheral surface 43c of the stator core body 43. The teeth 43b are disposed at equal intervals over one circumference along the circumferential direction.

The protruding portion 49 protrudes radially outward from the outer peripheral surface 43c of the stator core body 43. The protruding portion 49 is a fixing portion fixed to the motor housing 20. As showed in FIG. 3, the protruding portion 49 extends axially. The protruding portion 49 extends from, for example, an end portion of the stator core body 43 on the first axial side to an end portion of the stator core body 43 on the second axial side. Multiple protruding portions 49 are provided at intervals in the circumferential direction. For example, four protruding portions 49 are provided.

Each of the protruding portions 49 has a through-hole 49a that axially passes through the corresponding one of the protruding portions 49. The through-hole 49a is, for example, a circular hole. Although not showed, a bolt extending in the axial direction passes through the through-hole 49a. Although not showed, the bolt is allowed to pass through the through-hole 49a from the first axial side (−Y side) and is tightened into a female screw hole provided in the motor housing 20. As a result, the protruding portion 49 is fixed to the motor housing 20 by the bolt.

The protruding portions 49 includes a first protruding portion 44, a second protruding portion 45, a third protruding portion 46, and a fourth protruding portion 47. The first protruding portion 44, the second protruding portion 45, the third protruding portion 46, and the fourth protruding portion 47 are disposed apart from each other in the circumferential direction. In the present preferred embodiment, the first protruding portion 44 and the second protruding portion 45 are located above the central axis J. In the present preferred embodiment, the third protruding portion 46 and the fourth protruding portion 47 are located below the central axis J. The first protruding portion 44, the second protruding portion 45, the third protruding portion 46, and the fourth protruding portion 47 are disposed at equal intervals over one circumference in the circumferential direction, for example. The first protruding portion 44, the second protruding portion 45, the third protruding portion 46, and the fourth protruding portion 47 are identical in shape to each other, for example. Thus, the following description may not include description of shape of the protruding portions 49 other than the first protruding portion 44. In the present preferred embodiment, each protruding portion 49 has an asymmetrical shape in the circumferential direction.

The first protruding portion 44 is provided in an upper front end portion of the stator core body 43. The first protruding portion 44 protrudes upward and diagonally forward from the stator core body 43. The second protruding portion 45 is provided in an upper rear end portion of the stator core body 43. The second protruding portion 45 protrudes upward and diagonally rearward from the stator core body 43. The third protruding portion 46 is provided in a lower rear end portion of the stator core body 43. The third protruding portion 46 protrudes downward and diagonally rearward from the stator core body 43. The fourth protruding portion 47 is provided in a lower front end portion of the stator core body 43. The fourth protruding portion 47 protrudes downward and diagonally forward from the stator core body 43.

As showed in FIG. 2, the first protruding portion 44 is located on the first circumferential side (+θ side) from a pipe member 50. In the present preferred embodiment, the first protruding portion 44 is located on the first circumferential side from a vertex VP on an upper side of the stator core body 43. The vertex VP is located uppermost in the outer peripheral surface 43c of the stator core body 43. As viewed in the axial direction, the vertex VP is an intersection at which the outer peripheral surface 43c of the stator core body 43 intersects with a virtual line IL extending in the vertical direction through the central axis J. In the present preferred embodiment, the first protruding portion 44 has a radially outer end portion that is located below the vertex VP.

The first protruding portion 44 is disposed away from the inner peripheral surface of the motor housing 20. The first protruding portion 44 decreases in circumferential dimension radially outward. The radially outer end portion of the first protruding portion 44 has an outline in an arc or substantially arc shape that is convex radially outward as viewed in the axial direction. The first protruding portion 44 has a first side surface 44a directed toward the second circumferential side (−θ side) is an inclined surface inclined toward the first circumferential side (+θ side) from the outer peripheral surface 43c of the stator core body 43 radially outward. In the present preferred embodiment, the first side surface 44a faces upward and diagonally forward.

The first side surface 44a is connected at its radially inner end to the outer peripheral surface 43c of the stator core body 43. As viewed in the axial direction of the central axis J, the first side surface 44a extends along a tangent line tangent to a boundary portion P1a at which the radially inner end portion of the first side surface 44a is connected to the outer peripheral surface 43c of the stator core body 43. In the present preferred embodiment, the boundary portion P1a is located forward and downward from the vertex VP. Although not showed, the tangent line tangent to the boundary portion P1a inclines at an angle with respect to the front-back direction (X-axis direction) as viewed in the axial direction. The tangent line tangent to the boundary portion P1a is located more downward toward the front side.

The first side surface 44a is smoothly connected to the outer peripheral surface 43c of the stator core body 43. The first side surface 44a extends linearly, for example, as viewed in the axial direction. The first side surface 44a extends forward and diagonally downward from the boundary portion P1a as viewed in the axial direction. In the present preferred embodiment, the first side surface 44a is located more downward with distance from a first feed port 54 described later in the circumferential direction. The first side surface 44a is located more downward toward the front side of the vehicle on which the drive device 100 is mounted. That is, the first side surface 44a in the present preferred embodiment extends downward with distance from the pipe member 50 in the front-rear direction orthogonal to the vertical direction as viewed in the axial direction.

In the present preferred embodiment, the first side surface 44a corresponds to an inclined surface facing the first side in the first direction. That is, the stator core 41 in the present preferred embodiment has the first side surface 44a as the inclined surface facing the first side in the first direction.

The first protruding portion 44 has a second side surface 44b directed toward the first circumferential side (+θ side), and the second side surface 44b is an inclined surface inclined toward the second circumferential side (−θ side) from the outer peripheral surface 43c of the stator core body 43 radially outward. In the present preferred embodiment, the second side surface 44b faces forward and diagonally downward.

The second side surface 44b is connected at its radially inner end portion to the outer peripheral surface 43c of the stator core body 43. As viewed in the axial direction of the central axis J, the second side surface 44b extends in a direction inclined radially outward from a tangent line tangent to a boundary portion P1b at which the radially inner end portion of the second side surface 44b is connected to the outer peripheral surface 43c of the stator core body 43. In the present preferred embodiment, the boundary portion P1b is located forward and downward from the boundary portion P1a. Although not showed, the tangent line tangent to the boundary portion P1b inclines at an angle with respect to the front-back direction as viewed in the axial direction. The tangent line tangent to the boundary portion P1b is located more downward toward the front side. The tangent line tangent to the boundary portion P1b inclines more from the front-rear direction than the tangent line tangent to the boundary portion P1a.

The second side surface 44b is smoothly connected to the outer peripheral surface 43c of the stator core body 43. The second side surface 44b extends linearly, for example, as viewed in the axial direction. The second side surface 44b extends upward and diagonally forward from the boundary portion P1b as viewed in the axial direction.

The second protruding portion 45 is located on the second circumferential side (−θ side) from the pipe member 50. In the present preferred embodiment, the second protruding portion 45 is located on the second circumferential side from the vertex VP on the upper side of the stator core body 43. In the present preferred embodiment, the second protruding portion 45 has a radial outer end portion that is located above the radially outer end portion of the first protruding portion 44. The second protruding portion 45 has an upper end portion that is located below the vertex VP, for example.

The second protruding portion 45 has a third side surface 45a directed toward the first circumferential side (+θ side), and the third side surface 45a is an inclined surface inclined toward the second circumferential side (−θ side) from the outer peripheral surface 43c of the stator core body 43 radially outward. In the present preferred embodiment, the third side surface 45a faces upward and diagonally forward.

The third side surface 45a is connected at its radially inner end portion to the outer peripheral surface 43c of the stator core body 43. As viewed in the axial direction of the central axis J, the third side surface 45a extends in a direction inclined radially outward from a tangent line tangent to the boundary portion P2a at which the radially inner end portion of the third side surface 45a is connected to the outer peripheral surface 43c of the stator core body 43. In the present preferred embodiment, the boundary portion P2a is located rearward and downward from the vertex VP. Although not showed, the tangent line tangent to the boundary portion P2a inclines at an angle with respect to the front-back direction as viewed in the axial direction. The tangent line tangent to the boundary portion P2a is located more upward toward the front side.

The third side surface 45a is smoothly connected to the outer peripheral surface 43c of the stator core body 43. The third side surface 45a extends linearly, for example, as viewed in the axial direction. The third side surface 45a extends rearward and diagonally upward from the boundary portion P2a as viewed in the axial direction.

The second protruding portion 45 has a fourth side surface 45b directed toward the second circumferential side (−θ side), and the fourth side surface 45b is an inclined surface inclined toward the first circumferential side (+θ side) from the outer peripheral surface 43c of the stator core body 43 radially outward. In the present preferred embodiment, the fourth side surface 45b faces rearward and diagonally upward.

The fourth side surface 45b is connected at its radially inner end to the outer peripheral surface 43c of the stator core body 43. As viewed in the axial direction of the central axis J, the fourth side surface 45b extends along a tangent line tangent to a boundary portion P2b at which the radially inner end portion of the fourth side surface 45b is connected to the outer peripheral surface 43c of the stator core body 43. In the present preferred embodiment, the boundary portion P2b is located rearward and downward from the boundary portion P2a. Although not showed, the tangent line tangent to the boundary portion P2b inclines at an angle with respect to the front-back direction as viewed in the axial direction. The tangent line tangent to the boundary portion P2b is located more upward toward the front side. The tangent line tangent to the boundary portion P2b inclines more from the front-rear direction than the tangent line tangent to the boundary portion P2a.

The fourth side surface 45b is smoothly connected to the outer peripheral surface 43c of the stator core body 43. The fourth side surface 45b extends linearly, for example, as viewed in the axial direction. The fourth side surface 45b extends upward and diagonally forward from the boundary portion P2b as viewed in the axial direction.

As showed in FIG. 1, the coil assembly 42 includes multiple coils 42c attached to the stator core 41 along the circumferential direction. The multiple coils 42c are mounted on the respective teeth of the stator core 41 with respective insulators (not showed) interposed therebetween. The coil assembly 42 includes coil ends 42a and 42b that protrude axially from the stator core 41.

The rotary electric machine 10 includes a pipe member 50 in a hollow or substantially hollow shape accommodated inside the motor housing 20. In the present preferred embodiment, the pipe member 50 is in a tubular or substantially tubular shape extending in the axial direction. The pipe member 50 has axially opposite end portions supported by the motor housing 20. The pipe member 50 has the end portion on the second axial side (+Y side) that is supported by, for example, the partition wall 22. The pipe member 50 has the end portion on the first axial side (−Y side) that is supported by, for example, the lid 23. The pipe member 50 is located radially outside the stator 40. In the present preferred embodiment, the pipe member 50 is located above the stator 40.

As showed in FIG. 2, the pipe member 50 is located between the first protruding portion 44 and the second protruding portion 45 in the circumferential direction. In the present preferred embodiment, the pipe member 50 is disposed at a position closer to the second protruding portion 45 than to the first protruding portion 44 in the circumferential direction. The pipe member 50 is located, for example, above the boundary portion P2a between the second protruding portion 45 and the stator core body 43. As viewed in the vertical direction, the pipe member 50 is disposed overlapping an end portion of the third side surface 45a of the second protruding portion 45 on the first circumferential side (+θ side) and the outer peripheral surface 43c of the stator core body 43. The pipe member 50 is located inside the first tubular portion 21a. More specifically, the pipe member 50 is inserted between an upper portion of the inner peripheral surface of the first tubular portion 21a and an upper surface of the stator core 41. As showed in FIG. 3, the pipe member 50 has an interposition portion 51, a first end portion 52, and a second end portion 53.

As showed in FIG. 2, the interposition portion 51 is located between the outer surface of the stator core 41 and the inner surface of the motor housing 20. In the present preferred embodiment, the interposition portion 51 is located between the upper surface of the stator core 41 and the upper portion of the inner peripheral surface of the first tubular portion 21a. The interposition portion 51 has an upper portion located inside the first recess 21i. In the present preferred embodiment, the entire pipe member 50 excluding the first end portion 52 and the second end portion 53 is the interposition portion 51. In the present preferred embodiment, the interposition portion 51 is a body portion of the pipe member 50. A placement relationship between the interposition portion 51 and the stator core 41 is similar to a placement relationship between the pipe member 50 and the stator core 41 described above. The interposition portion 51 is located radially outside the stator 40. In the present preferred embodiment, the interposition portion 51 is located above the stator 40.

As showed in FIG. 3, the interposition portion 51 has an axial dimension that is larger than an axial dimension of the stator core 41. The interposition portion 51 protrudes on both sides in the axial direction from the stator core 41. The interposition portion 51 is disposed over an upper side of the stator core 41 and an upper side of the coil ends 42a and 42b. As showed in FIG. 2, the interposition portion 51 is sandwiched between the outer surface of the stator core 41 and the inner surface of the motor housing 20 in a sandwiching direction, and has a dimension in the sandwiching direction that is smaller than a dimension in a direction orthogonal to the sandwiching direction as viewed in the axial direction. In the present preferred embodiment, the sandwiching direction in which the interposition portion 51 is sandwiched by the outer surface of the stator core 41 and the inner surface of the motor housing 20 is the vertical direction. That is, the interposition portion 51 has a dimension in the vertical direction that is smaller than that in the front-rear direction. The interposition portion 51 is, for example, in a shape in which a cylinder is crushed in the vertical direction, i.e., in a tubular or substantially tubular shape with a cross-section that is taken along a direction orthogonal to the axial direction and is in a substantially elliptical shape with a flat portion.

As showed in FIG. 3, the first end portion 52 is connected to an end portion of the interposition portion 51 on the first axial side (−Y side). The first end portion 52 is in a cylindrical or substantially cylindrical shape that opens toward the first axial side. The first end portion 52 is an end portion of the pipe member 50 on the first axial side. The first end portion 52 is, for example, fitted into a hole (not showed) provided in the lid 23 and supported by the lid 23. From the first end portion 52, the oil O flows into the inside of the pipe member 50.

The second end portion 53 is connected to an end portion of the interposition portion 51 on the second axial side (+Y side). The second end portion 53 is in a cylindrical or substantially cylindrical shape that opens toward the second axial side. The second end portion 53 is an end portion of the pipe member 50 on the second axial side. The second end portion 53 is, for example, fitted into a hole (not showed) provided in the partition wall 22 and supported by the partition wall 22. In the present preferred embodiment, the oil O in the pipe member 50 flows in a direction from the first axial side (−Y side) toward the second axial side (+Y side). That is, the oil O in the pipe member 50 flows in the direction in which the first axial side is an upstream side and the second axial side is a downstream side.

The pipe member 50 has a feed port 50a for feeding the oil O as a refrigerant to the stator 40. In the present preferred embodiment, the feed port 50a is an injection port that injects partially the oil O having flowed into the pipe member 50 to the outside of the pipe member 50. Multiple feed ports 50a are provided. In the present preferred embodiment, all the feed ports 50a are provided in the interposition portion 51. The feed port 50a is, for example, in a circular or substantially circular shape. In the present preferred embodiment, the feed ports 50a provided in the interposition portion 51 include multiple first feed ports 54 facing the first circumferential side (+θ side) and multiple second feed ports 55 facing the second circumferential side (−θ side).

As showed in FIG. 2, the pipe member 50 overlaps a first region 24a provided inside the motor housing 20 as viewed in the axial direction. The first region 24a is located between the outer surface of the stator core 41 and the inner surface of the motor housing 20 as viewed in the axial direction. In the present preferred embodiment, the first region 24a is located between the upper surface of the stator core 41 and a lower surface of the sidewall 21h in the second tubular portion 21c as viewed in the axial direction. The first region 24a is located above the stator core 41. The first region 24a is located on the rear side (−X side) from the virtual line IL as viewed in the axial direction.

In the present preferred embodiment, the first region 24a includes a placement region 24c. As viewed in the axial direction, the pipe member 50 overlaps the placement region 24c. In the present preferred embodiment, the placement region 24c is located between a portion of the outer surface of the stator core 41, the portion including the boundary portion P2a between the stator core body 43 and the second protrusion 45, and a portion of the inner surface of the motor housing 20, the portion including an inner surface of the first recess 21i, as viewed in the axial direction. In the present preferred embodiment, the placement region 24c is a lower portion of the first region 24a.

The rotary electric machine 10 includes an inverter device 80 electrically connected to the stator 40. The inverter device 80 includes a power element 82, a capacitor 83, and an inverter case 81 for accommodating the power element 82 and the capacitor 83 inside. In the present preferred embodiment, the inverter case 81 is located above the motor housing 20. More specifically, the inverter case 81 has a front portion located above the body 21. The inverter case 81 has a rear portion protruding toward the rear side (−X side) from the motor housing 20. The rear portion of the inverter case 81 has a vertical dimension that is larger than a vertical dimension of the front portion of the inverter case 81. The rear portion of the inverter case 81 protrudes downward from the front portion of the inverter case 81. The rear portion of the inverter case 81 is connected to an upper portion of the first tubular portion 21a on the rear side (−X side). The inverter case 81 has a case body 81a and a cover 81b.

The case body 81a is in a box shape that opens upward. The case body 81a is connected to an upper portion of the body 21 of the motor housing 20. More specifically, the case body 81a is connected to an upper portion of the first tubular portion 21a. In the present preferred embodiment, the case body 81a and the body 21 are each a part of a single member. The case body 81a includes wall portions in which a wall 81c is located on the first axial side (−Y side) and partially constitutes an upper portion of the flange portion 21b. The wall 81c has a portion that constitutes the flange portion 21b and that is provided with the through-hole 21d described above. In the present preferred embodiment, the through-hole 21d passes through the wall 81c in the axial direction. The cover 81b is fixed to an upper portion of the case body 81a. The cover 81b closes an opening in the upper portion of the case body 81a.

The power element 82 is, for example, a transistor such as an insulated gate bipolar transistor (IGBT). Although not showed, multiple power elements 82 are provided. The multiple power elements 82 constitute an inverter circuit electrically connected to the stator 40. In the present preferred embodiment, the power element 82 is located inside the front portion of the inverter case 81. The power element 82 is located above the stator core 41. At least a part of the power element 82 overlaps the stator core 41 as viewed in the vertical direction. In the present preferred embodiment, the entire power element 82 overlaps the stator core 41 as viewed in the vertical direction.

The capacitor 83 is, for example, an electrolytic capacitor. In the present preferred embodiment, the capacitor 83 is located inside the rear portion of the inverter case 81. The capacitor 83 is located outside the stator core 41 as viewed in the vertical direction. In other words, the capacitor 83 does not overlap the stator core 41 as viewed in the vertical direction. The capacitor 83 has a vertical dimension that is larger than a vertical dimension of the power element 82. The capacitor 83 is electrically connected to the power element 82. At least a part of the capacitor 83 overlaps the stator core 41 as viewed in the front-rear direction. In the present preferred embodiment, a lower portion of the capacitor 83 overlaps the stator core 41 as viewed in the front-rear direction.

The rotary electric machine 10 includes a bus bar unit 84. Although not showed, the bus bar unit 84 extends in the axial direction. The bus bar unit 84 is inserted into the through-hole 21d in the axial direction. The bus bar unit 84 is disposed across the inside of the motor housing 20 and the inside of the inverter case 81. The bus bar unit 84 includes a bus bar 84a that electrically connects the stator 40 and the inverter device 80, and a bus bar holder 84b that holds the bus bar 84a. That is, the rotary electric machine 10 includes the bus bar 84a and the bus bar holder 84b.

In the present preferred embodiment, the bus bar 84a extends in the axial direction and is inserted into the through-hole 21d in the axial direction. The bus bar 84a electrically connects the coil 42c and the power element 82. Multiple bus bars 84a are provided. For example, three bus bars 84a are provided. The bus bar 84a has a portion inserted into the through-hole 21d, the portion being in a plate or substantially plate shape with a plate surface facing the vertical direction. The multiple bus bars 84a are disposed side by side across a gap in the vertical direction in the through-hole 21d. In the present preferred embodiment, the bus bar 84a is located above the first side surface 44a as viewed in the axial direction.

In the present preferred embodiment, the bus bar holder 84b is made of a resin having insulating properties. In the bus bar holder 84b, the bus bar 84a is partially embedded and held. The bus bar holder 84b is made by, for example, insert molding in which the bus bar 84a is an insert member. The bus bar holder 84b is, for example, in a square columnar or substantially square columnar shape extending in the axial direction.

The bus bar 84a and the bus bar holder 84b overlap a second region 24b provided inside the motor housing 20 as viewed in the axial direction. The second region 24b is located between the outer surface of the stator core 41 and the inner surface of the motor housing 20 as viewed in the axial direction. In the present preferred embodiment, the second region 24b is located between the upper surface of the stator core 41 and a lower surface of the sidewall 21h in the second tubular portion 21c as viewed in the axial direction. The second region 24b is disposed apart from the first region 24a in the circumferential direction. The second region 24b is located on the first circumferential side (+θ side) from the first region 24a. The second region 24b is located on the front side (+X side) apart from the first region 24a.

The second region 24b is located above the stator core 41. The second region 24b is located on the front side (+X side) from the virtual line IL as viewed in the axial direction. In the present preferred embodiment, the first region 24a and the second region 24b are disposed across the virtual line IL in the front-rear direction as viewed in the axial direction. Thus, the pipe member 50 overlapping the first region 24a and the bus bar 84a overlapping the second region 24b are disposed on both respective sides across the virtual line IL extending vertically through the central axis J as viewed in the axial direction. In the present preferred embodiment, the entire bus bar unit 84 and the through-hole 21d overlap the second region 24b as viewed in the axial direction.

The second region 24b is wider than the first region 24a. The text, “the second region is wider than the first region” as used herein means that the second region needs to have a dimension larger than a dimension of the first region only in at least one direction. In the present preferred embodiment, the second region 24b has a dimension in the vertical direction that is larger than a dimension of the first region 24a in the vertical direction. The second region 24b has a dimension in the front-rear direction that is larger than a dimension of the first region 24a in the front-rear direction. The second region 24b has a dimension in the radial direction that is larger than a dimension of the first region 24a in the radial direction. The second region 24b has an area larger than an area of the first region 24a.

As showed in FIG. 1, the drive device 100 in the present preferred embodiment is provided with the refrigerant flow path 90 through which the oil O as a refrigerant circulates. The refrigerant flow path 90 is provided throughout from the inside of the motor housing 20 to the inside of the gear housing 61. The refrigerant flow path 90 allows the oil O stored in the gear housing 61 to be fed to the rotary electric machine 10 and to return to the inside of the gear housing 61 again. The refrigerant flow path 90 is provided with a pump 96, a cooler 97, and the pipe member 50. In the following description, an upstream side in a flow direction of the oil O in the refrigerant flow path 90 is simply referred to as an “upstream side”, and a downstream side in the flow direction of the oil O in the refrigerant flow path 90 is simply referred to as a “downstream side”. The refrigerant flow path 90 includes a gear-side flow path portion 91, a connection flow path portion 92, and a rotary-electric-machine-side flow path portion 93.

The gear-side flow path portion 91 includes a first portion 91a and a second portion 91b. The first portion 91a and the second portion 91b are provided, for example, in a wall portion of the gear housing 61. The first portion 91a allows a portion with the oil O stored, inside the gear housing 61, to communicate with the pump 96. The second portion 91b allows the pump 96 to communicate with the cooler 97.

The connection flow path portion 92 is provided from in a wall portion of the gear housing 61 to in a wall portion of the motor housing 20. The connection flow path portion 92 allows the gear-side flow path portion 91 to communicate with the rotary-electric-machine-side flow path portion 93. More specifically, the connection flow path portion 92 allows the cooler 97 to communicate with a third flow path portion 93c described later.

The rotary-electric-machine-side flow path portion 93 is provided in the rotary electric machine 10. The rotary-electric-machine-side flow path portion 93 includes a first flow path portion 93a, a second flow path portion 93b, and a third flow path portion 93c. That is, the rotary electric machine 10 includes the first flow path portion 93a, the second flow path portion 93b, and the third flow path portion 93c. The first flow path portion 93a and the third flow path portion 93c are each provided in a wall portion of the motor housing 20. The second flow path portion 93b includes a housing flow path portion 93d provided in a wall portion of the motor housing 20, and the pipe member 50. In the present preferred embodiment, the first flow path portion 93a, the third flow path portion 93c, and the housing flow path portion 93d are provided in the lid 23. The third flow path portion 93c communicates with the first flow path portion 93a and the second flow path portion 93b. In the present preferred embodiment, the first flow path portion 93a and the second flow path portion 93b branch from the third flow path portion 93c.

The first flow path portion 93a allows the oil O as a fluid to be fed into the inside of the hole 23f. The first flow path 93a has an end portion on the upstream side that communicates with an end portion of the third flow path 93c on the downstream side. The end portion of the first flow path portion 93a on the downstream side opens to the inside of the hole 23f. Although not showed, the end portion of the first flow path portion 93a on the downstream side opens, for example, in an end portion of an inner peripheral surface of the hole 23f on the first axial side (−Y side).

The second flow path portion 93b allows the oil O as a fluid to be fed to the stator 40. The second flow path 93b has an end portion upstream from the housing flow path 93d, the end portion communicating with an end portion of the third flow path 93c on the downstream side. The housing flow path portion 93d has an end portion on the downstream side that communicates with an end portion of the pipe member 50 on the upstream side.

When the pump 96 is driven, the oil O stored in the gear housing 61 is sucked up through the first portion 91a and flows into the cooler 97 through the second portion 91b. The oil O having flowed into the cooler 97 is cooled in the cooler 97, and then flows through the connection flow path portion 92 and flows into the rotary-electric-machine-side flow path portion 93 from the third flow path portion 93c. The oil O having flowed into the third flow path portion 93c branches into the first flow path portion 93a and the second flow path portion 93b. The oil O having flowed into the first flow path portion 93a flows into the inside of the hole 23f.

The oil O having flowed into the inside of the hole 23f partially flows into the inside of the shaft 31 through the inside of the nozzle member 70. The oil O having flowed into the shaft 31 from the nozzle member 70 passes through the inside of the rotor body 32 from the hole 33 and scatters to the stator 40. The oil O having flowed into the inside of the hole 23f is partially fed to the bearing 35.

The oil O having flowed into the second flow path portion 93b flows into the inside of the pipe member 50 through the housing flow path portion 93d. The oil O having flowed into the pipe member 50 is injected from the feed port 50a and fed to the stator 40. As described above, providing the first flow path portion 93a and the second flow path portion 93b, which branch from the third flow path portion 93c, enables the oil O fed from the inside of the gear housing 61 to be suitably and easily fed into the shaft 31 through the hole 23f and to be fed to the stator 40 from the pipe member 50.

In the present preferred embodiment, the oil O scooped up by the ring gear 63a partially enters a reservoir 98 provided in the gear housing 61. The oil O having entered the reservoir 98 flows into the shaft 31 from its end portion on the second axial side (+Y side). The oil O having flowed into the shaft 31 from the reservoir 98 passes through the inside of the rotor body 32 from the hole 33 and scatters to the stator 40.

The oil O fed to the stator 40 from the feed port 50a and the oil O fed to the stator 40 from the inside of the shaft 31 take heat from the stator 40. The oil O having cooled the stator 40 falls downward to accumulate in a lower region in the motor housing 20. The oil O accumulated in the lower region in the motor housing 20 returns to the inside of the gear housing 61 through the partition wall opening 22a provided in the partition wall 22. As described above, the refrigerant flow path 90 allows the oil O stored in the gear housing 61 to be fed to the rotor 30 and the stator 40.

According to the present preferred embodiment, the motor housing 20 is provided inside with the first region 24a and the second region 24b wider than the first region 24a as viewed in the axial direction. The pipe member 50 overlaps the first region 24a as viewed in the axial direction. The bus bar 84a overlaps the second region 24b as viewed in the axial direction. Here, the bus bar 84a is likely to increase in size as compared with the pipe member 50. Thus, disposing the bus bar 84a at a position overlapping the second region 24b wider than the first region 24a as viewed in the axial direction enables the bus bar 84a to be easily disposed in the motor housing 20. Then, disposing the pipe member 50, which is likely to decrease in size as compared with the bus bar 84a, at a position overlapping the first region 24a narrower than the second region 24b, enables an internal space of the motor housing 20 to be prevented from enlarging unnecessarily. As described above, when two regions different in size are provided in the motor housing 20 to allow the pipe member 50 and the bus bar 84a to be disposed at positions overlapping the corresponding two regions in the axial direction in accordance with sizes of the pipe member 50 and the bus bar 84a, the pipe member 50 and the bus bar 84a can be disposed in a space-efficient manner inside the motor housing 20. This facilitates reduction in size of the motor housing 20. Thus, the present preferred embodiment enables reduction in size of the rotary electric machine 10 including the pipe member 50 and the inverter device 80. Additionally, the drive device 100 provided with the rotary electric machine 10 can be reduced in size. The present preferred embodiment facilitates reduction in size of the motor housing 20 in the vertical direction, so that the rotary electric machine 10 and the drive device 100 can be reduced in size in the vertical direction.

According to the present preferred embodiment, the first region 24a includes the placement region 24c located between a portion of the outer surface of the stator core 41, the portion including the boundary portion P2a between the stator body 43 and the second protruding portion 45, and the inner surface of the motor housing 20, as viewed in the axial direction. Thus, disposing the pipe member 50 at a position overlapping the placement region 24c as viewed in the axial direction enables the pipe member 50 and the second protruding portion 45 to be disposed collectively side by side in the circumferential direction. This facilitates reduction in internal space of the motor housing 20 as compared with when a space for disposing the pipe member 50 is separately provided at a position different from that of the second protruding portion 45. Thus, the motor housing 20 can be easily further reduced in size, and thus the rotary electric machine 10 can be easily further reduced in size.

According to the present preferred embodiment, the first region 24a includes the placement region 24c located between the outer surface of the stator core 41 and a portion of the inner surface of the motor housing 20, the portion including the inner surface of the first recess 21i, as viewed in the axial direction. This facilitates securing the placement region 24c while bringing the inner surface of the motor housing 20 close to the outer surface of the stator core 41. As a result, disposing the pipe member 50 at a position overlapping the placement region 24c as viewed in the axial direction facilitates further reduction in size of the motor housing 20 while the pipe member 50 is suitably disposed inside the motor housing 20. Thus, the rotary electric machine 10 can be easily reduced in size.

According to the present preferred embodiment, the pipe member 50 has the interposition portion 51 located between the outer surface of the stator core 41 and the inner surface of the motor housing 20. As viewed in the axial direction, the interposition portion 51 is sandwiched between the outer surface of the stator core 41 and the inner surface of the motor housing 20 in a sandwiching direction, and has a dimension in the sandwiching direction that is smaller than a dimension in a direction orthogonal to the sandwiching direction. Thus, the interposition portion 51 can be easily and relatively reduced in dimension in the sandwiching direction. This enables the stator core 41 to be disposed with the outer surface brought further close to the inner surface of the motor housing 20 while the interposition portion 51 is disposed between the outer surface of the stator core 41 and the inner surface of the motor housing 20. Thus, the motor housing 20 can be easily further reduced in size, and thus the rotary electric machine 10 can be easily further reduced in size.

According to the present preferred embodiment, at least a part of the power element 82 overlaps the stator core 41 as viewed in the vertical direction. The capacitor 83 is located outside the stator core 41 as viewed in the vertical direction. The capacitor 83 is likely to increase in size as compared with the power element 82. Disposing the capacitor 83 relatively large in size outside the stator core 41 as viewed in the vertical direction enables at least a part of the capacitor 83 to be disposed side by side with the stator core 41 in a direction orthogonal to the vertical direction. Thus, the inverter device 80 can be prevented from protruding in the vertical direction from the motor housing 20 as compared with when the capacitor 83 overlaps the stator core 41 as viewed in the vertical direction. This facilitates reduction in size of the rotary electric machine 10 in the vertical direction. Even when the power element 82 relatively small in size is disposed overlapping the stator core 41 as viewed in the vertical direction, the rotary electric machine 10 is less likely to increase in size in the vertical direction. Additionally, a part of the inverter device 80 can be disposed overlapping the motor housing 20 in the vertical direction. Thus, the inverter device 80 can be prevented from protruding in a direction orthogonal to the vertical direction from the motor housing 20 as compared with when the entire inverter device 80 does not overlap the stator core 41 as viewed in the vertical direction. This facilitates reduction in size of the rotary electric machine 10 in the direction orthogonal to the vertical direction. As described above, the rotary electric machine 10 can be reduced in size in the vertical direction and in the direction orthogonal to the vertical direction while being provided with the inverter device 80.

According to the present preferred embodiment, the stator core 41 has the first side surface 44a as an inclined surface facing upward. The first side surface 44a extends downward with distance from the pipe member 50 in the front-rear direction orthogonal to the vertical direction as viewed in the axial direction. The bus bar 84a is located above the first side surface 44a, which is an inclined surface, as viewed in the axial direction. Inclining the first side surface 44a in a downward direction with distance from the pipe member 50 as described above enables preventing the motor housing 20 from protruding upward in a portion where the second region 24b is provided while the second region 24b located opposite to the first region 24a across the virtual line IL is increased in size in the vertical direction. This enables preventing the motor housing 20 from increasing in size in the vertical direction while securing the second region 24b that overlaps the bus bar 84a as viewed in the axial direction and is relatively large in size. Thus, the rotary electric machine 10 can be further reduced in size in the vertical direction.

According to the present preferred embodiment, the pipe member 50 and the bus bar 84a are located above the stator core 41 as viewed in the axial direction. Disposing the pipe member 50 and the bus bar 84a on an identical side in the vertical direction from the stator core 41 enables preventing the motor housing 20 from increasing in size in the vertical direction as compared with when the pipe member 50 is disposed opposite to the bus bar 84a across the stator core 41 in the vertical direction. Thus, the rotary electric machine 10 can be further reduced in size in the vertical direction.

According to the present preferred embodiment, the first direction in which the virtual line IL extends is the vertical direction. Thus, the rotary electric machine 10 and the drive device 100 each can be reduced in size in the vertical direction as described above. This enables the drive device 100 to be easily mounted on the vehicle.

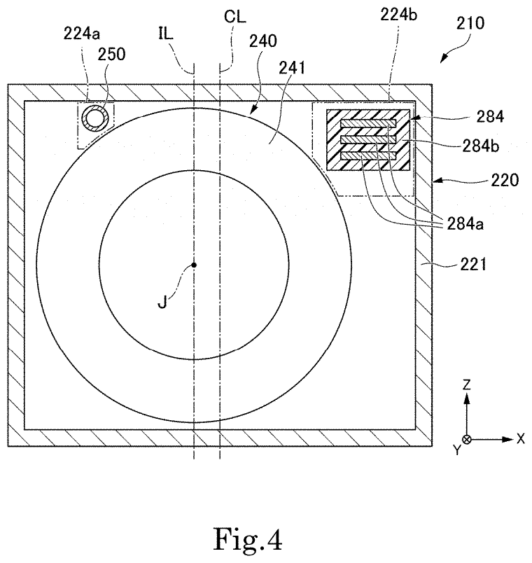

As showed in FIG. 4, a rotary electric machine 210 of the present preferred embodiment includes a motor housing 220 that has a body 221 in a rectangular tubular or substantially rectangular tubular shape. In the present preferred embodiment, the body 221 has an outer shape viewed in the axial direction that is a rectangular or substantially rectangular shape long in the front-rear direction. FIG. 4 virtually illustrates a center line CL extending in the vertical direction through the center of the body 221 in the front-rear direction as viewed in the axial direction. As viewed in the axial direction, the center line CL passes through the center of the motor housing 220 in the front-rear direction. In the present preferred embodiment, the center line CL is disposed on the front side (+X side) from a virtual line IL.

In the present preferred embodiment, an outer peripheral surface of a stator core 241 of a stator 240 is in a cylindrical or substantially cylindrical shape about a central axis J. Unlike the pipe member 50 of the first preferred embodiment, a pipe member 250 is in a cylindrical shape rather than a shape with a flat portion of a cross-section taken along a direction orthogonal to the axial direction. The pipe member 250 overlaps a first region 224a provided on the rear side (−X side) from the virtual line IL extending in the vertical direction through the central axis J as viewed in the axial direction. As viewed in the axial direction, a bus bar unit 284 overlaps a second region 224b provided on the front side (+X side) from the virtual line IL. That is, a bus bar 284a and a bus bar holder 284b overlap the second region 224b as viewed in the axial direction. The first region 224a and the second region 224b are located between an outer surface of the stator core 241 and an inner surface of the body 221 as viewed in the axial direction.

In the present preferred embodiment, the center line

CL is disposed on the front side (+X side) from the virtual line IL as described above. That is, the motor housing 220 is displaced with the center in the front-rear direction orthogonal to the vertical direction, the center being closer to the bus bar 284a than the virtual line IL as viewed in the axial direction. Thus, a distance between a wall portion of the motor housing 220 located on the front side and the stator core 241 in the front-rear direction can be increased to more than a distance between a wall portion of the motor housing 220 located on the rear side (−X side) and the stator core 241 in the front-rear direction. This enables the second region 224b wider than the first region 224a to be easily provided in the motor housing 220, for example, without providing the stator core 241 with an inclined surface such as the first side surface 44a. Other configurations of the rotary electric machine 210 can be made similarly to other configurations of the rotary electric machine 10. The pipe member 250 may have a cross-section in a shape with a flat portion, being taken along a direction orthogonal to the axial direction, as in the pipe member 50 of the first preferred embodiment. In this case, the stator core 241 can be brought close to an inner surface of the motor housing 220 on an upper side (+Z side) in the vertical direction as viewed in the axial direction. Thus, the motor housing 220 can be reduced in dimension in the vertical direction, and thus the motor housing 220 can be reduced in size.

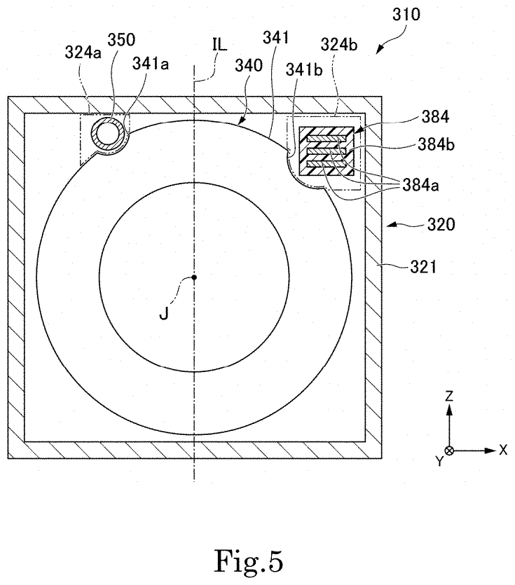

As showed in FIG. 5, a rotary electric machine 310 of the present preferred embodiment includes a motor housing 320 that has a body 321 in a rectangular tubular or substantially rectangular tubular shape. In the present preferred embodiment, the body 321 has an outer shape viewed in the axial direction that is a square shape. In the present preferred embodiment, an outer peripheral surface of a stator core 341 of a stator 340 is in a cylindrical or substantially cylindrical shape about a central axis J. As viewed in the axial direction, the stator core 341 has an outer surface provided with a second recess 341a and a third recess 341b that are recessed toward the central axis J. The second recess 341a and the third recess 341b are recessed radially inward from an outer peripheral surface of the stator core 341. In the present preferred embodiment, the second recess 341a and the third recess 341b each have an inner surface in a substantially arcuate shape as viewed in the axial direction. The second recess 341a and the third recess 341b are located above the central axis J. The second recess 341a is located on the rear side (−X side) from a virtual line IL. The third recess 341b is located on the front side (+X side) from the virtual line IL. The second recess 341a is recessed diagonally forward and downward. The third recess 341b is recessed diagonally rearward and downward. The third recess 341b has a dimension in the radial direction that is larger than a dimension of the second recess 341a in the radial dimension.

In the present preferred embodiment, the first region 324a includes a region located between a portion of an outer surface of the stator core 341, the portion including an inner surface of the second recess 341a, and an inner surface of the motor housing 320, as viewed in the axial direction. Thus, the first region 324a between the outer surface of the stator core 341 and the inner surface of the motor housing 320 can be increased in size without increasing the motor housing 320 in size. This allows a pipe member 350 to easily overlap the first region 324a as viewed in the axial direction while suppressing increase in size of the rotary electric machine 310. In the present preferred embodiment, the pipe member 350 is in a cylindrical or substantially cylindrical shape as with the pipe member 250 of the second preferred embodiment. The pipe member 350 is partially located inside the second recess 341a. The pipe member 350 may have a cross-section in a tubular shape with a flat portion, being taken along a direction orthogonal to the axial direction, as in the pipe member 50 of the first preferred embodiment. In this case, the stator core 341 can be brought close to the inner surface of the motor housing 320 on the upper side (+Z side) in the vertical direction. Thus, the motor housing 320 can be reduced in dimension in the vertical direction, and thus the motor housing 320 can be reduced in size.

In the present preferred embodiment, the second region 324b includes a region located between a portion of the outer surface of the stator core 341, the portion including an inner surface of the third recess 341b, and the inner surface of the motor housing 320, as viewed in the axial direction. Thus, the second region 324b between the outer surface of the stator core 341 and the inner surface of the motor housing 320 can be increased in size without increasing the motor housing 320 in size. This enables a bus bar unit 384 including a bus bar 384a and a bus bar holder 384b to easily overlap the second region 324b as viewed in the axial direction while suppressing increase in size of the rotary electric machine 310. As described above, the dimension of the third recess 341b in the radial direction is larger than the dimension of the second recess 341a in the radial direction, so that the second region 324b can be easily made wider than the first region 324a. In the present preferred embodiment, the bus bar 384a and the bus bar holder 384b are each partially located inside the third recess 341b. Other configurations of the rotary electric machine 310 can be made similarly to other configurations of the rotary electric machine 10.

The present invention is not limited to the above-described preferred embodiment, and other structures and other methods may be employed within the scope of the technical idea of the present invention. The shape of the first region and the shape of the second region are not particularly limited. The first region and the second region may be provided at any position inside the housing as long as they are disposed apart from each other in the circumferential direction as viewed in the axial direction. The power element and the capacitor in the inverter device may be disposed in any way. Both the power element and the capacitor may overlap the stator core or may be located outside the stator core as viewed in the first direction. The first direction in which the virtual line passing through the central axis as viewed in the axial direction extends is not particularly limited, and the virtual line may extend in a direction other than the vertical direction. The shape of the stator core is not particularly limited.

The rotary electric machine to which the present invention is applied is not limited to a motor, and may be a generator. The rotary electric machine is not limited in application. For example, the rotary electric machine may be mounted on a vehicle for uses other than rotating an axle, or may be mounted on an apparatus other than the vehicle. The rotary electric machine is not particularly limited in attitude when being used. The rotary electric machine may have the central axis extending in the vertical direction. The structures and methods described above in the present specification can be appropriately combined within a range consistent with each other.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A rotary electric machine comprising:
a rotor rotatable about a central axis;
a stator having a stator core facing the rotor across a gap;
a housing for accommodating the rotor and the stator inside;
an inverter device electrically connected to the stator;
a bus bar electrically connecting the stator and the inverter device; and
a pipe member in a hollow shape accommodated inside the housing,
the housing being provided inside with:
a first region located between an outer surface of the stator core and an inner surface of the housing as viewed in an axial direction; and
a second region located between the outer surface of the stator core and the inner surface of the housing as viewed in the axial direction while being disposed apart from the first region in a circumferential direction,
the second region being wider than the first region,
the pipe member overlapping the first region as viewed in the axial direction, and
the bus bar overlapping the second region as viewed in the axial direction.

2. The rotary electric machine according to claim 1, wherein
the stator core includes
a stator core body having an outer peripheral surface in a cylindrical shape surrounding the rotor, and
a protruding portion protruding radially outward from the stator core body, and
the first region includes a region located between a portion of the outer surface of the stator core, the portion including a boundary portion between the stator core body and the protruding portion, and the inner surface of the housing as viewed in the axial direction.

3. The rotary electric machine according to claim 1, wherein
the inner surface of the housing is provided with a first recess that is recessed toward the outer surface of the housing, and
the first region includes a region located between the outer surface of the stator core and a portion of the inner surface of the housing, the portion including an inner surface of the first recess, as viewed in the axial direction.

4. The rotary electric machine according to claim 1, wherein
the pipe member includes an interposition portion located between the outer surface of the stator core and the inner surface of the housing, and
the interposition portion is sandwiched between the outer surface of the stator core and the inner surface of the housing in a sandwiching direction, and has a dimension in the sandwiching direction that is smaller than a dimension of the interposition portion in a direction orthogonal to the sandwiching direction as viewed in the axial direction.

5. The rotary electric machine according to claim 1, wherein
the pipe member and the bus bar are disposed on both respective sides across a virtual line extending in a first direction through the central axis as viewed in the axial direction,
the inverter device includes
a power element, and
a capacitor
at least a part of the power element overlaps the stator core as viewed in the first direction, and
the capacitor is located outside the stator core as viewed in the first direction.

6. The rotary electric machine according to claim 1, wherein
the pipe member and the bus bar are disposed on both the respective sides across the virtual line extending in the first direction through the central axis as viewed in the axial direction,
the stator core has an inclined surface facing a first side in the first direction,
the inclined surface extends in a direction toward a second side in the first direction with distance from the pipe member in a second direction orthogonal to the first direction as viewed in the axial direction, and
the bus bar is located on the first side in the first direction from the inclined surface as viewed in the axial direction.

7. The rotary electric machine according to claim 1, wherein
the pipe member and the bus bar are disposed on both respective sides across a virtual line extending in the first direction through the central axis as viewed in the axial direction, and
the housing is disposed with a center in the second direction orthogonal to the first direction, the center being closer to the bus bar than the virtual line, as viewed in the axial direction.

8. The rotary electric machine according to claim 5, wherein
the pipe member and the bus bar are located on the first side in the first direction from the stator core as viewed in the axial direction.

9. The rotary electric machine according to claim 5, wherein
the first direction is a vertical direction.

10. The rotary electric machine according to claim 1, wherein
the outer surface of the stator core is provided with:
a second recess that is recessed toward the central axis; and
a third recess that is recessed toward the central axis and has a larger dimension in the radial direction than the second recess,
the first region includes a region located between a portion of the outer surface of the stator core, the portion including an inner surface of the second recess, and the inner surface of the housing, as viewed in the axial direction, and
the second region includes a region located between a portion of the outer surface of the stator core, the portion including an inner surface of the third recess, and the inner surface of the housing, as viewed in the axial direction.

11. A drive device mounted on a vehicle, the drive device comprising:
the rotary electric machine according to claim 1; and
a transmission device connected to the rotary electric machine to transmit rotation of the rotary electric machine to an axle of the vehicle.
